(19) United States
(12) Patent Application Publication
(10) Pub. No.: US 2006/0140411 A1
(43) Pub. Date: Jun. 29, 2006

(54) Ciphering key management and distribution in mbms

(76) Inventor: Yanmin Zhu, District Beijing (CN)

Correspondence Address: DILWORTH & BARRESE, LLP, 333 EARLE OVINGTON BLVD., UNIONDALE, NY, 11553, US

(21) Appl. No.: 10/529,411

(22) PCT Filed: Sep. 30, 2003
(86) PCT No.: PCT/KR03/02001

§ 371 Date: Dec. 29, 2005

(30) Foreign Application Priority Data
Sep. 30, 2002 (CN) 02 1 44083.2

(51) Int. Cl. H04L 9/00

(52) U.S. Cl. 380/277

(57) ABSTRACT

A method for key management and assignment in MBMS service, the method includes following steps: the group key locates in the root node on the highest layer, which only has child nodes and doesn't have parent nodes; private keys corresponding to users locate in leaf nodes; the described intermediate node that owns both one parent node and one or more child nodes holds it own key. This invention deploys the method of combining point-to-point mode and point-to-multipoint mode during the process of key update; compared with the key update method only deploying point-to-point mode, this method can reduce the times necessary for information transmission, reduce the system load as well as the time needed for one key update process. Compared with the key update method only deploying point-to-multipoint mode, this solves the security problem of key exposure.

### BACKGROUND OF THE INVENTION

1. Field of the Invention

This invention relates to Multimedia Broadcast and Multicast Service (hereinafter referred to as MBMS) and more particularly, relates to a method for key management and assignment in Multimedia Broadcast and Multicast Service.

2. Description of the Prior Art

MBMS is a new service under standardization by 3^{rd} Generation Mobile Communication System Partnership Project. MBMS service is an unidirectional point-to-multipoint (p-t-m) (i.e. multimedia data sent from a single data source are transferred to multiple users through mobile communication network) service, whose most remarkable characteristic is that it can make use of radio resources and network resources efficiently. MBMS service is mainly used in wireless communication network system, e.g. Wideband Code-Division Multiple Access system, Global System for Mobile Communication, etc. MBMS service data transfer basically includes following several steps, i.e. data source transmission, intermediate network transmission, destination cell on-air transmission and user reception. FIG. 16 is the logical figure for network devices of the radio communication system that can provide MBMS service, in which MBMS actually makes use of General Packet Radio Data Service (hereinafter referred to as GPRS) as core transmission network. As shown in FIG. 16, Broadcast and Multicast Service Center (hereinafter referred to as BM-SC) is the data source for MBMS data transmission; Gateway GPRS Supporting Node (hereinafter referred to as GGSN) is used to connect GRPS network with external network such as INTERNET. in MBMS service, GGSN is used to comnect BM-SC and to send MBMS data to specific Serving GPRS Supporting Node (hereinafter referred to as SGSN); Cell Broadcast Center (hereinafter referred to as CBC) is the data resource of cell broadcast. CBC can be allowed to provide MBMS service announcing function by interconnecting CBC with BM-SC in MBMS; SGSN is used to perform access control and mobility management on UE, and also sends MBMS data from GGSN to specific Radio Network Controller (hereinafter referred to as RNC) at the same time; RNC is used to control a group of Node B and sends multimedia data to specific NODE B; NODE B establishes on-air physical channel for MBMS service in a certain cell under the control of RNC; Terminal User Equipment (hereinafter referred to as UE) is the terminal equipment for MBMS data reception.

In FIG. 17, it provides the whole process from service announcement, user joining, service notification, radio bearer set up till user's final leaving in MBMS service.

000 Subscription—Establish the connection between user and service provider. Authorized user can receive relevant MBMS service.

001 Service announcement—Inform user of services that will be provided. For example, the system will rebroadcast a football match in Beijing at 7:00 p.m.

002 Joining—Indicate that user joins a group, i.e. the user informs the is network that he or she is willing to receive this multicast service.

003 MBMS multicast bearer set up—Establish network resources for MBMS data transfer.

004 MBMS notification—Inforn user about forthcoming (and potentially about ongoing) MBMS data transfer.

005 Data transfer—Indicate the process of transferring MBMS service data to user.

006 MBMS multicast bearer release—Release network resources when MBMS service data transfer is finished.

007 Leaving corresponds to 002 joining, and indicates that a user is leaving a group, i.e. the user doesn't want to receive the data of a certain service any more.

In a wireless communication network system, information exchange between a user and the network system is to be accomplished via transmission channels. Generally there are two kinds of transmission channels in wireless communication network system, i.e. dedicated channel occupied by a single user or common channel shared by multiple users. Generally, transmission based on point-to-point (i.e. the data sent from a data source are transferred to one user for receiving through network transmission) is achieved via dedicated channel, while transmission based on point-to-multipoint is achieved via common channel. In common, to guarantee the security of data transmission on a dedicated channel occupied solely by a user, each user connected to the wireless communication network system owns a private key that is only known by himself/herself and the network system; data transmission conducted on the dedicated channel between the user and the network system are encrypted by the private key. And as a common channel is shared by multiple users, data transmission on the common channel generally is not encrypted. To make use of radio resources and network resources efficiently, MBMS service data can be transmitted via common channel. At this time, taking aspects such as accounting and security into account, MBMS service data transnitted via common channels generally need to be encrypted to ensure that those data are only meaningful for those users who can receive them. So, besides his/her private key, a MBMS service user shall also need to know the MBMS service group keys.

As for a group of users that locate in a certain service region and are receiving the same kind of MBMS service, the group keys used for the encryption of MBMS service data shall be the same in order to make use of radio resources and network resources efficiently, since MBNS is a point-to-multipoint service. Therefore, users needn't to change different group keys due to their movements within the service range of the MBMS service. But in many situations, this group key shall be updated constantly. For example, when a user leaves active so as not to receive current MBMS service any more, or the user is regarded not suitable to receive current MBMS service any more by the network and then made to leave passively for some reason like accounting, the group keys need to be updated and to be notified to all other users to avoid that the user can continue to receive MBMS service by making use of the old group key.

In existing systems, the assignment of group keys is generally performed in two ways: i.e. one-by-one transmission by point-to-point transfer for each user or transmission by point-to-multipoint broadcast for all users. As for one-by-one transmission by point-to-point transfer, the transmission of the group key are encrypted by the corresponding private key for each user in the MBMS service group, which can guarantee that information delivered to the user won't be utilized by other users. If the number of members in group is large and the members varies constantly, this mode will bring extremely heavy load on the system since the system needs to notify each of the members in group one by one by point-to-point transfer for each key update process. Thus, it will take a long time for updating group key each time, thereby reducing the efficiency greatly. While performning the assignment by point-to-multipoint broadcast for all users, the new group key is encrypted by using the old group key and is transmitted by broadcast; user can make use of the old group key for decryption to obtain the new group key. As the user having left the MBMS service may still keep the old group key, he/she may make use of the old group key for decryption to obtain the new group key. So, the problem of insecurity for key exposure exists in this key assignment method by point-to-multipoint broadcast.

### SUMMARY OF THE INVENTION

Therefore, it is an object of the invention to provide a safe and highly efficient key management and assignment method suitable for multimedia broadcasting or multicasting service that can alleviate system load and reduce time expense.

To achieve the aim, a method for key management and assignment in MBMS service includes following steps:

A group key locates in the root node on the highest layer, which has only child nodes but has no parent nodes;

Private keys corresponding to users locate in leaf nodes, which are the users of MBMS service;

Intermediate node, which owns both a parent node and one or more child nodes, has its own key.

To achieve another aspect of the above object, a method for key management and assignment for information encryption in a radio network system which includes a root node, plurality of intermediate nodes in the root node and plurality of leaf nodes in each intermediate nodes of the radio network system providing Multimedia Broadcast or Multicast service, comprising the steps of:

generating a group key for the root node which has plurality of intermediate nodes as child nodes;

generating intermediate key using the group key for each of the intermediate nodes that owns both one parent node and one or more child nodes having its own intermediate key;

requesting a leaf node key in a user equipment (UE) for the service: and

delivering a private key as a leaf node key to the UE on a dedicate channel.

This invention uses a method of combining point-to-point mode and point-to-multipoint mode during the process of key update. Compared with the key update method only usinig point-to-point mode, this method can reduce the times necessary for information delivery, reduce the system load as well as the time necessary for one key update process. And compared with the key update method only deploying point-to-multipoint mode, this method solves the insecurity problem of key exposure.

### BRIEF DESCRIPTION OF THE DRAWINGS

The above and other features and advantages of the present invention will become more apparent by describing in detail exemplary embodiments thereof with reference to the attached drawings in which:

FIG. 1 shows the logical structure for MBMS group key assignment;

FIG. 2 is the figure illustrating key assignment management and logical network device according to the first embodiment of the invention;

FIG. 3 is the schematic figure of key update assignment corresponding to FIG. 2 when a new user joins MBMS service without causing key update of other nodes;

FIG. 4 is the flowchart corresponding to FIG. 3;

FIG. 5 is the schematic figure of key update assignment corresponding to FIG. 2 when a new user joins MBMS service, which causes key update of other nodes;

FIG. 6 is the flowchart corresponding to FIG. 5;

FIG. 7 is the schematic figure of key update assignment corresponding to FIG. 2 when a user leaves MBMS service;

FIG. 8 is the flowchart corresponding to FIG. 7;

FIG. 9 is the figure for key assignment management and logical network device according to the second embodiment of the invention;

FIG. 10 is the schematic figure of key update assignment corresponding to FIG. 9 when a new user joins MBMS service without causing key update of other nodes;

FIG. 11 is the flowchart corresponding to FIG. 10;

FIG. 12 is the schematic figure of key update assignment corresponding to FIG. 9 when a new user joins MBMS service, which causes key update of other nodes;

FIG. 13 is the flowchart corresponding to FIG. 12;

FIG. 14 is the schematic figure of key update assignment corresponding to FIG. 9 when a user leaves MBMS service;

FIG. 15 is the flowchart corresponding to FIG. 14;

FIG. 16 is the figure illustrating the logical network device of wireless communication system for MBMS service;

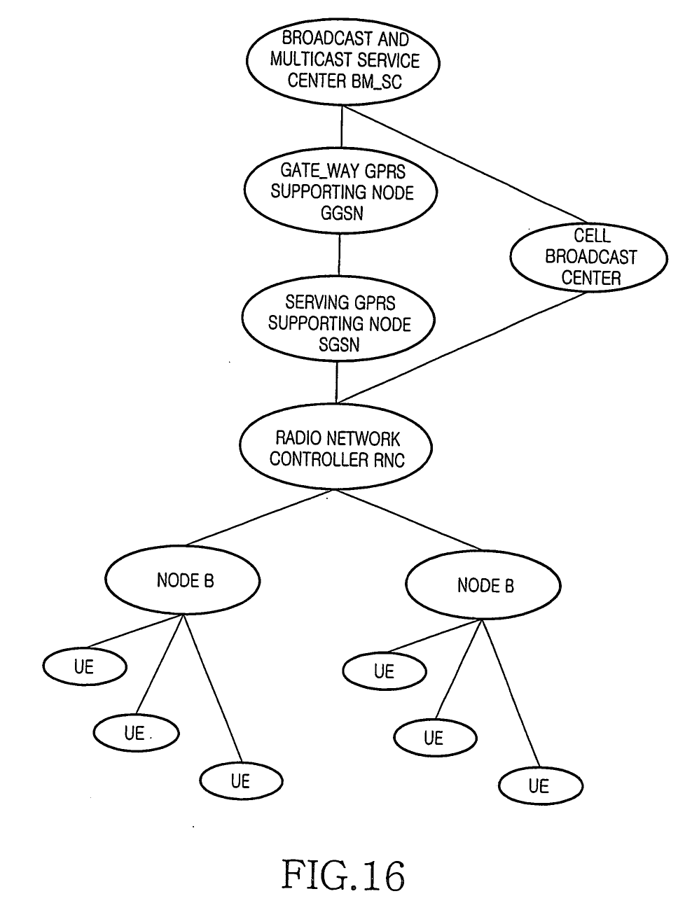

FIG. 17 is the flowchart of MBMS multicast service;

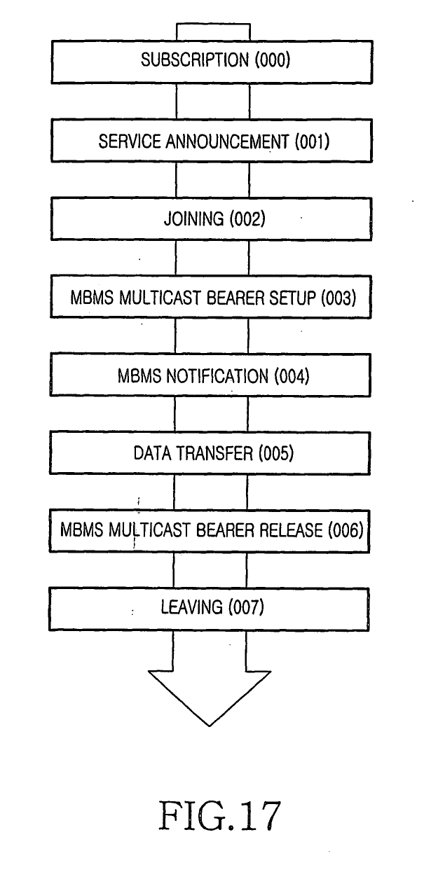

### DETAILED DESCRIPTION OF THE INVENTION

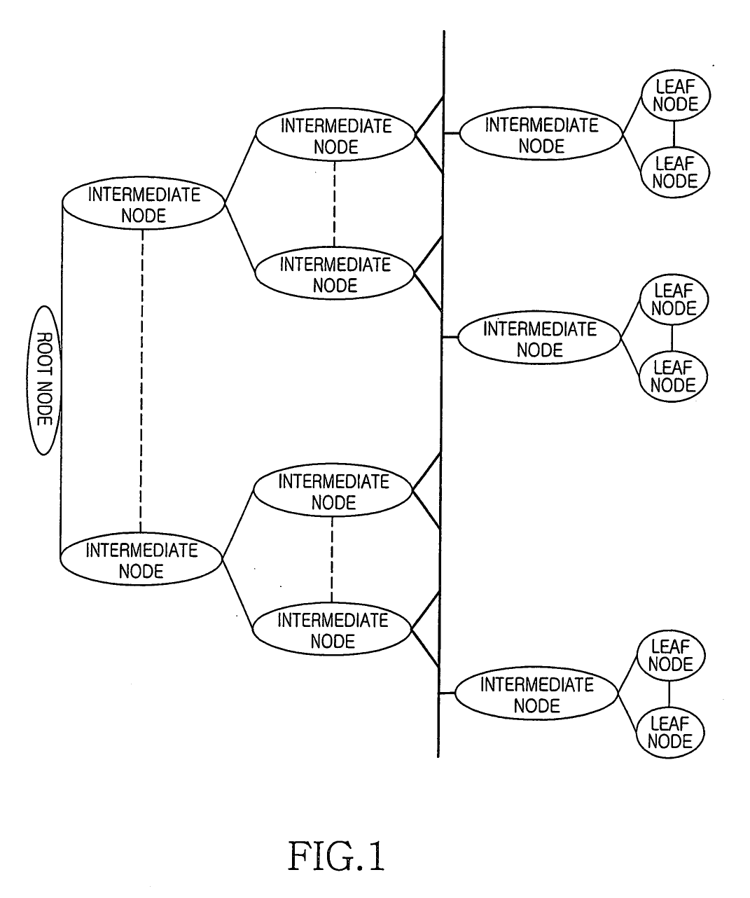

This invention provides a safe and highly efficient key management and assignment method suitable for MBMS service, which can alleviate system load and reduce time expense. It deploys the method of combining point-to-point mode and point-to-multipoint mode during single process of key assignment. FIG. 1 illustrates logical structure for MBMS group key assignment. The key assignment deploys the arrangement of multi-layer tree structure from root node to respective intermediate nodes, and then to leaf node. Leaf nodes at the lowest layer only have parent nodes and don't have child nodes; intermediate nodes can own one or more child nodes, but can only have one parent node; root nodes at the highest layer only have child node and doesn't have parent node. Different nodes have different node keys. MBMS service users are assigned to different leaf nodes. The leaf node key is the private key corresponding to each user and the root node key is the group key. Each user keeps node key information on all nodes that the node chain passes by from the leaf node where he/she locates to the root node of the tree, including leaf node, intermediate nodes of respective layers and the root node. MBMS service data are encrypted by using root node key and are transmitted each user.

According to one aspect of the invention, a new MBMS service user is connected to the tree via its parent node as a new leaf node. This user needs to obtain keys of all nodes includina intermediate nodes on respective layers and the root node that are passed by the node chain from the access parent node to the root node of the tree. These node keys won't be updated due to the joining of the user. The transmissions of these node keys are sent to the user in point-to-point mode, and are encrypted by using the key of the new leaf node (i.e. the private key of the user).

According to another aspect of the invention, a newly-joined MBMS service user is connected to the tree via its access parent node as a new leaf node. This user needs to obtain keys of all nodes including intermediate nodes on respective layers and the root node that are passed by the node chain from the access parent node to the root node of the tree. These node keys will be updated due to the joining of the user. For this newly-joined user,. the transmissions of these new node keys are sent to the user in point-to-point mode and are encrypted by using the key of the new leaf node (i.e. the private key of the user). In addition, for each of these nodes, the new key will be encrypted by using the old key and be delivered to the final leaf node user that they belong to respectively.

According to another aspect of the invention, when a user leaves MBMS service, its leaf node will be disconnected from its parent node. Keys of all nodes that are passed by the node chain from the disconnected node to the root node of the tree are updated sequentially. For each node that needs to update its key, the update of parent node key is performed after other child nodes keys finish updating; the new parent node key is transferred to all other child nodes (except for the disconnected leaf nodes) one by one in point-to-point mode and is encrypted by using the key of each child node respectively; and each child node delivers it in point-to-multipoint mode to final leaf node user that it belongs to respectively.

This patent relates to a method for key mnanagement and assignment in Multimedia Broadcast and Multicast Service; In fact, it deploys the method of combining point-to-point mode and point-to-multipoint mode during the process of key assignment to perform key management and assignment, which can ensure security and high efficiency, and reduce the system load and time expenses. With reference to the attached drawing, tvo different embodiments of this invention are given in the following. To avoid making the description of the invention be unclear, detailed descriptions for functions or devices well-known to those skilled in the art are omitted herein.

### THE FIRST EMBODIMENT

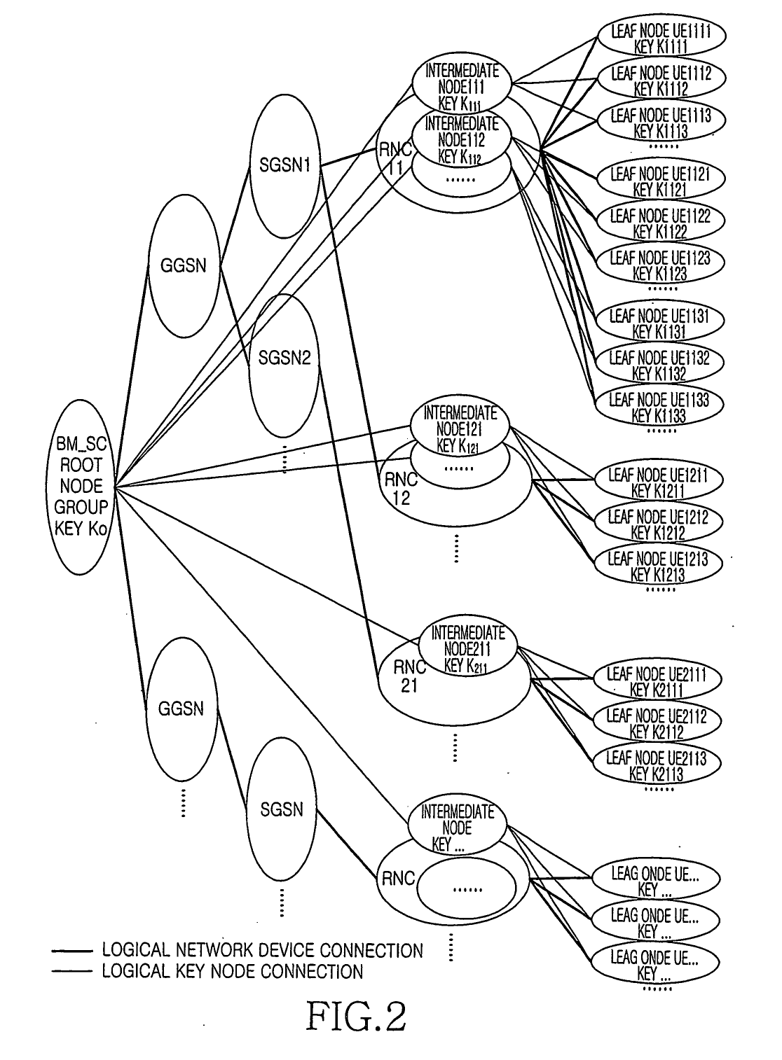

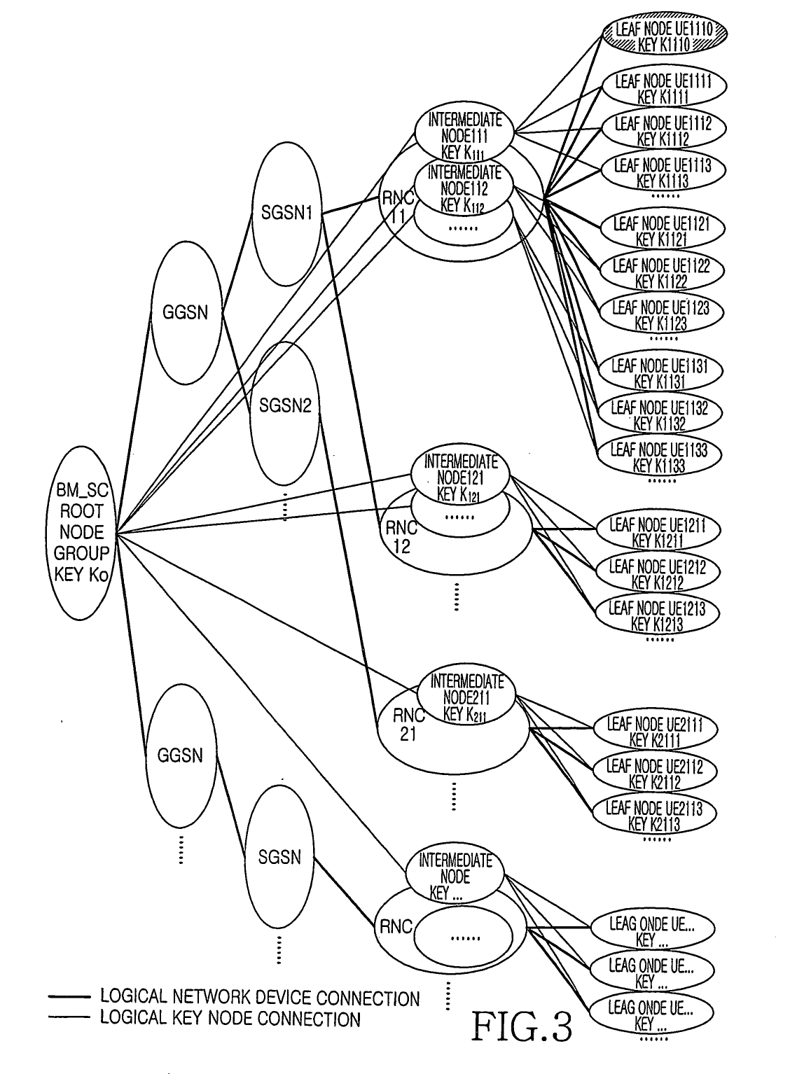

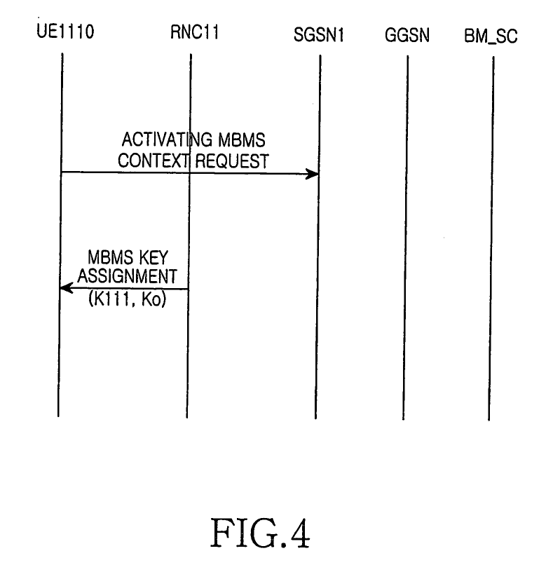

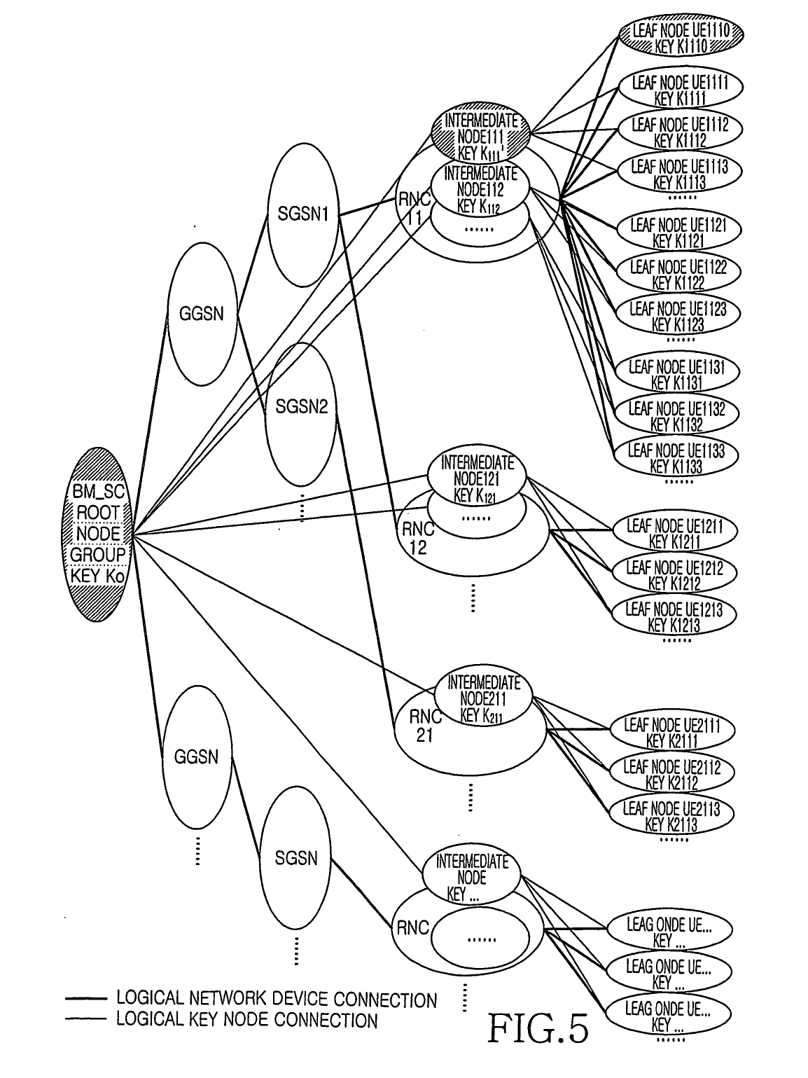

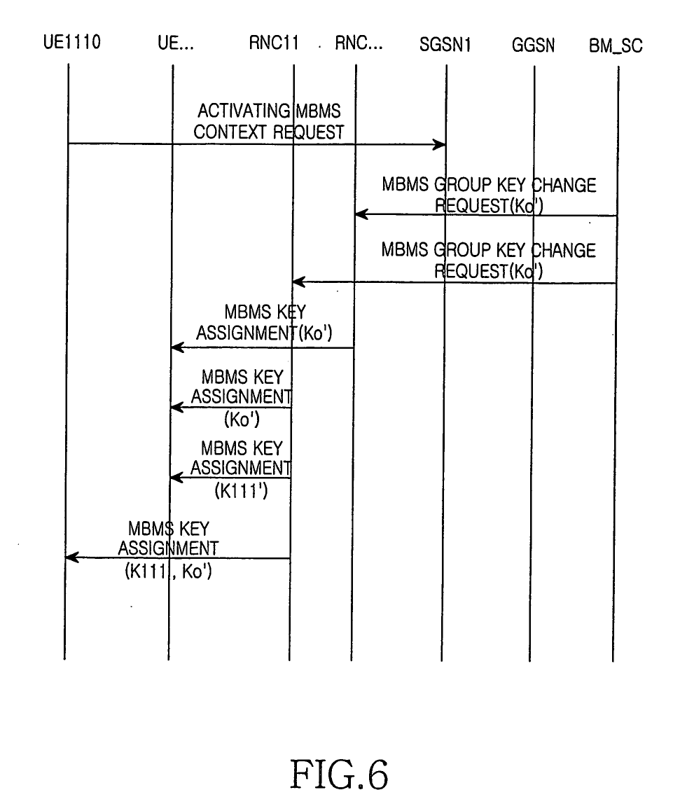

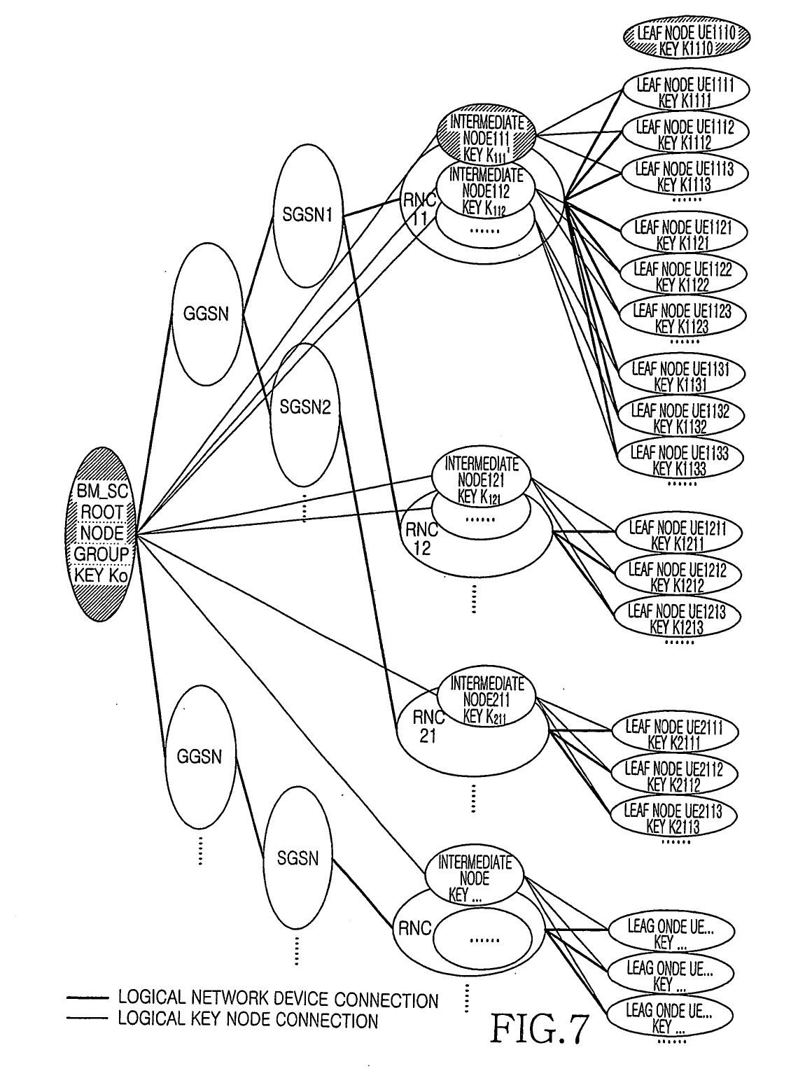

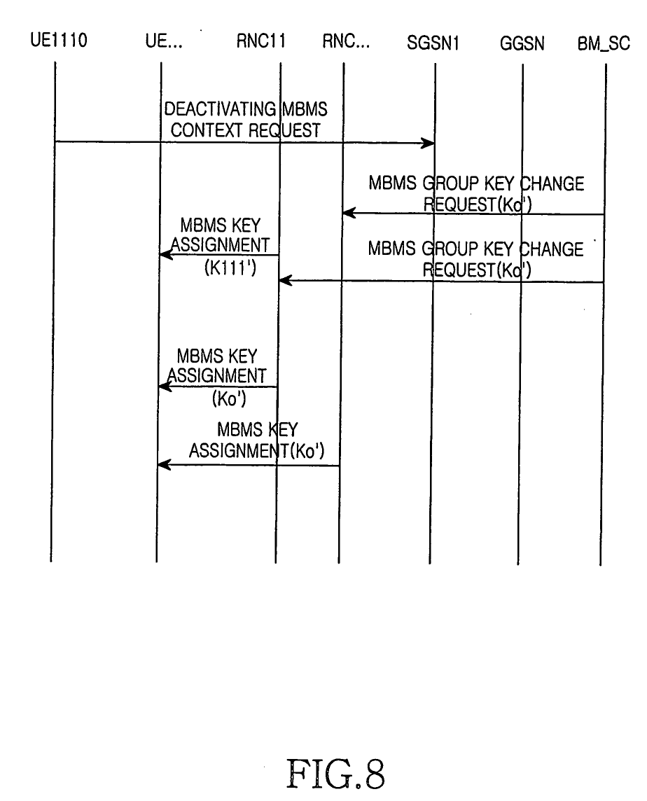

FIG. 2 illustrates key assignment management and logical network device of the first embodiment. In this embodiment, the management of respective node key is accomplished by different logical network devices, and the information encryption process is accomplished by RNC. FIG. 3 is the schematic figure of the corresponding key update assignment when a new user joins MBMS service without causing key updates of other nodes. FIG. 4 is the flowchart corresponding to FIG. 3. FIG. 5 is the schematic figure of the corresponding key update assignment when a new user joins MBMS service, which causes to key updates of other nodes FIG. 6 is the flowchart corresponding to FIG. 5. FIG. 7 is the schematic figure of the corresponding key update assignment when a user leaves MBMS service. FIG. 8 is the flowchart corresponding to FIG. 7.

Now refer to FIG. 2. A BM_SC is connected to several GGSNs at downstream side and provides services for these GGSNs. Each GGSN is connected respectively to several SGSNs at downstream side and provides services for these SGSNs. Each SGSN is connected respectively to several RNCs at downstream side and provides services for these RNCs. Each RNC can aso provide services for several user equipments (UEs) at the same time. The solid lines in the figure indicate the connections between these logical network device entities.

All users within the service range of this BM_SC are regarded as one MBMS service group, and key assignment within the group is divided into three layers. BM_SC acts as the root node, whose key Ko is exactly the group key. All users under a RNC are divided into several sub-groups, and each sub-group corresponds with one intermediate node. For example, RNC11 manages several intermediate nodes, e.g. 111, 112, . . . , and assigns nodes keys K₁₁₁, K₁₁₂, . . . for them respectively. When each UE acts as a leaf node, whose key is exactly the private key of the user. For example, the leaf node key of UE 1111 is K₁₁₁₁ and that of UE 1121 is K₁₁₂₁. The dotted lines in the figure indicates the connections between these logic key nodes. Each UE keeps node key information on all nodes that passed by the node chain from the leaf node where he/she locates to the root node of the tree, including leaf node, intermediate nodes of respective layers and the root node. For example, UE 1111 keeps the keys K₁₁₁₁, K₁₁₁ and Ko; UE 1112 keeps the keys K₁₁₁₂, K₁₁₁ and Ko; UE 1121 keeps the keys K₁₁₂₁, K₁₁₂ and Ko; and UE 1211 keeps the keys K₁₂₁₁, K₁₂₁, and Ko. MBMS service data are encrypted and transmitted with the root node key Ko.

Please refer to FIG. 3 and FIG. 4. The private key assigned by the wireless communication network system to UE 1110 is K₁₁₁₀. This UE desires to receive MBMS service of current BM_SC and it sends a request to SGSN1 by “Activating MBMS context request” message. After the wireless communication network system finishes a series of operations, it accepts this request. The UE is connected to the tree via its access parent node 111 as a new leaf node 1110. This user desires to obtain the node key K₁₁₁ of its access parent node 111 and the key Ko of the root node. The keys K₁₁₁ and Ko won't be updated due to the joining of the user. The keys K₁₁₁ and Ko are sent to the user by RNC11 via the dedicated channel only used by the user as parameters of the “MBMS key assignment” message in point-to-point mode. The information transferred on the dedicated channel only used by the user includes “MBMS key assignment” message and is encrypted by the leaf node key K₁₁₁₀ of the user (i.e. the private key of the user).

Please refer to FIG. 5 and FIG. 6. The private key assigned by the wireless communication network system to UE 1110 is K₁₁₁₀. This UE desires to receive MBMS service of current BM_SC and it sends a request to SGSN1 by “Activating MBMS context request” message. After the wireless communication network system finishes a series of operations, it accepts this request. The user is connected to the tree via its access parent node 111 as a new leaf node 1110. This UE needs to obtain the node key K₁₁₁ of its access parent node 111 and the key Ko of the root node. The keys K₁₁₁ and Ko will be updated to be K₁₁₁′ and Ko′ respectively due to the joining of the user. The keys K₁₁₁′ and Ko′ are sent to the user by RNC11 via the dedicated channel only used by the user as parameters of the “MBMS key assignment” message in point-to-point mode. The information transferred on the dedicated channel used by only the user includes “MBMS key assignment” message and is encrypted by the leaf node key K₁₁₁₀ of the user (i.e. the private key of the user).

In addition, the new key K₁₁₁′ is notified in point-to-multipoint mode to all other leaf node's users 1111, 1112, 1113, etc. that locate under the same parent node 111 as the UE 1110 does. The new key K₁₁₁′ is sent to the final leaf node user by RNC11 via the common channel as a parameter of the “MBMS key assignment” message in point-to-multipoint mode. This “MBMS key assignment” message is encrypted with the old key K₁₁₁ by RNC11.

In addition, the new root node key Ko′ is notified to all other leaf node's users that locate under the same root node BM_SC as the UE 1110 does in point-to-multipoint mode. The new key Ko′ is sent from BM_SC to each SGSN via GGSN as a parameter included in the “MBMS group key change request” message, and SGSN sends it to each corresponding RNC as a parameter included in “Request for radio access bearer assinment” message. Then, the new key Ko′ is delivered to the final leaf node's users by each RNC as a parameter of “MBMS key assignment” message via the common channel in point-to-multipoint mode. This “MBMS key assignment” message is encrypted with the old key Ko by RNC.

Please refer to FIG. 7 and FIG. 8. The private key assigned by the wireless communication network system for UE 1110 is K₁₁₁₀. This UE chooses to leave MBMS service of current BM_SC and it sends a message of “Deactivating MBMS context request” to SGSN1 via RNC11. After the wireless communication network system finishes a series of operations, it accepts this request. The leaf node 1110 is disconnected from its parent node 111. The node keys K₁₁₁ and Ko of the disconnected node 111 and the root node BM_SC are updated to the new keys K₁₁₁′ and Ko′ respectively and the update of Ko is performed after K₁₁₁ update finishes. The new key K₁₁₁′ is sent to all other leaf node's users 1111, 1112, 1113, etc., which locate under the same parent node 111 as UE 1110 does, sequentially by RNC11 via the dedicated channel used by respective user as a parameter of the “MBMS key assignment” message in point-to-point mode. Information transferred on the dedicated channel of each user is encrypted with the leaf node key of the user (i.e. the private key of the user). The new key Ko′ is sent from BM_SC to each SGSN via GGSN as a parameter included in the “MBMS group key change request” message, and SGSN sends it to each corresponding RNC as a parameter included in “Radio access bearer assignment request” message. Then, the new key Ko′ is delivered to the final leaf node's users of each intermediate node sequentially by each RNC as a parameter of “MBMS key assignment” message via the common channel in point-to-multipoint mode. The contents of “MBMS key assignment” message are encrypted by each RNC with corresponding intermediate node keys K₁₁₁′, K₁₁₂ . . . , K₁₂₁ . . . , K₂₁₁ . . . .

### THE SECOND EMBODIMENT

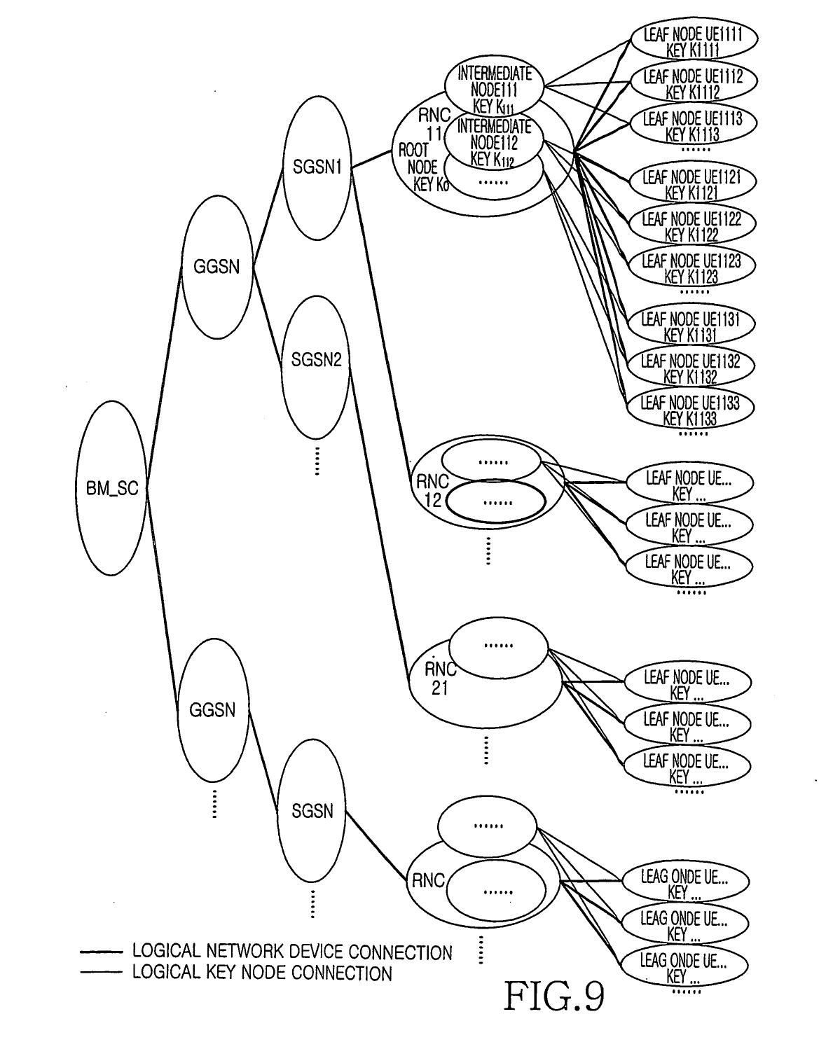

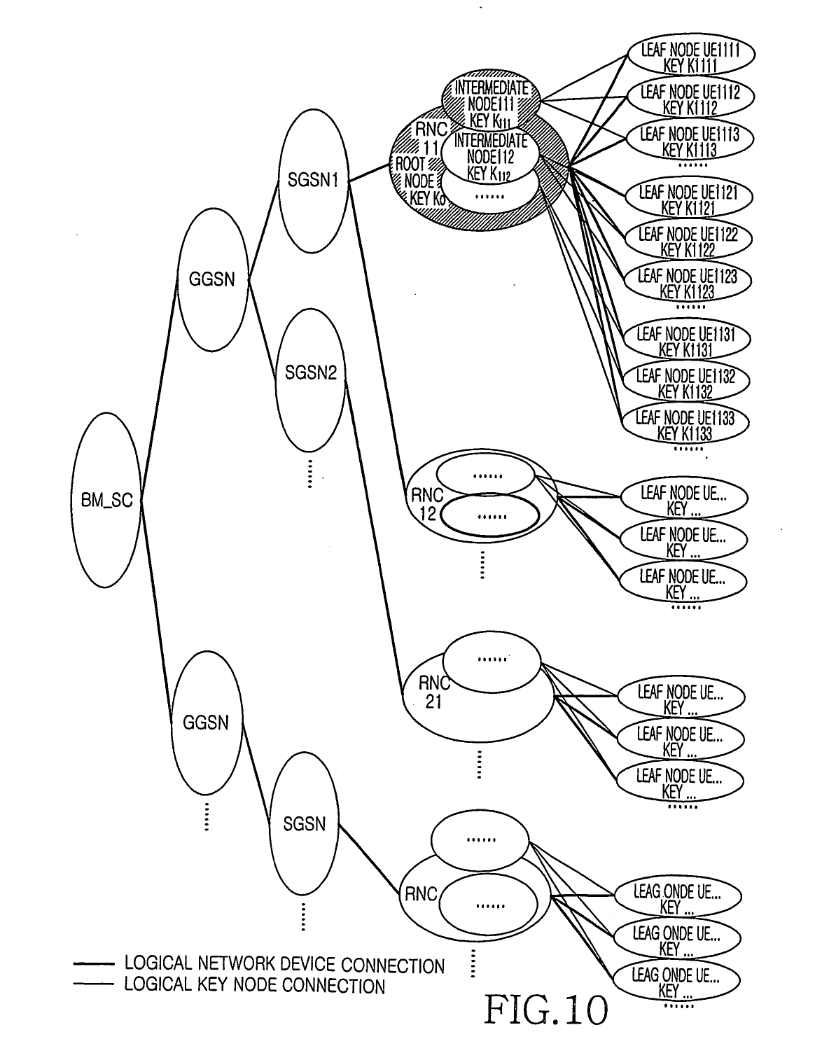

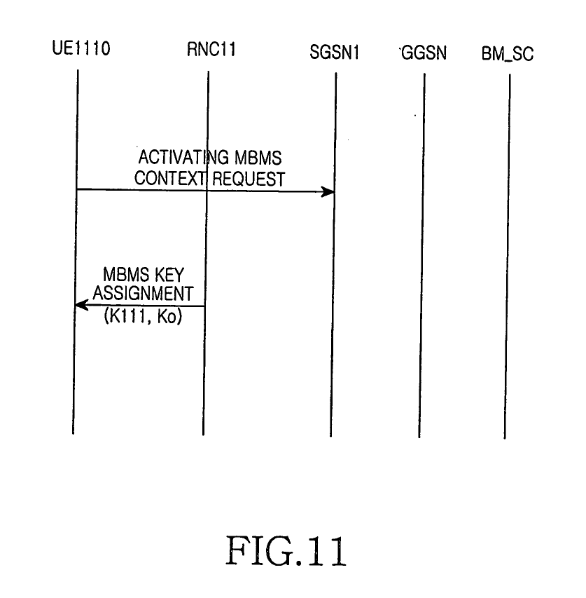

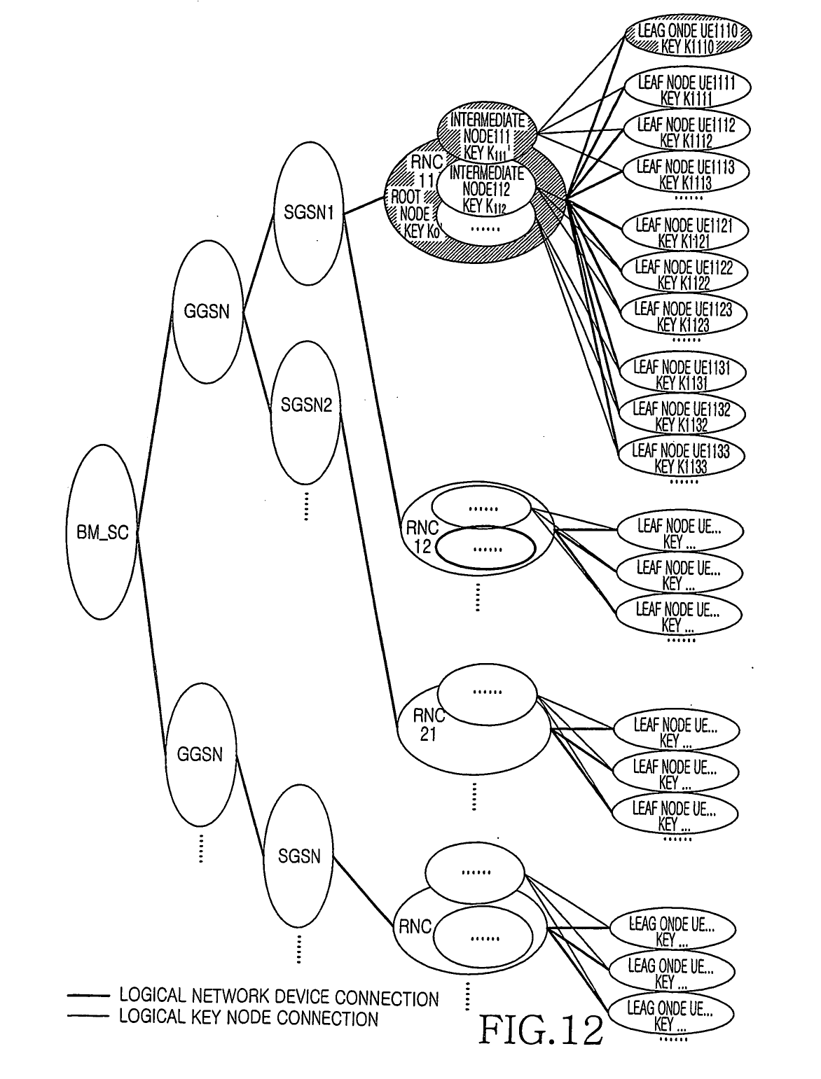

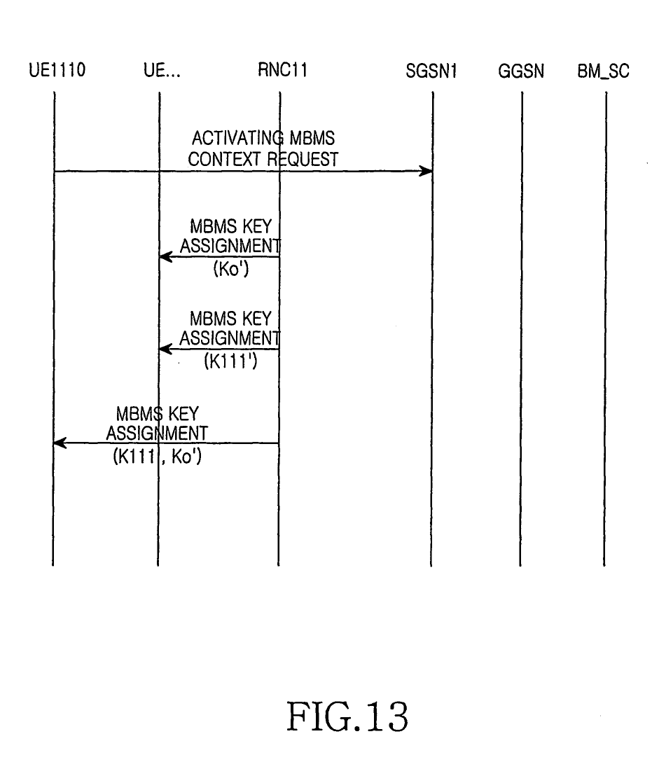

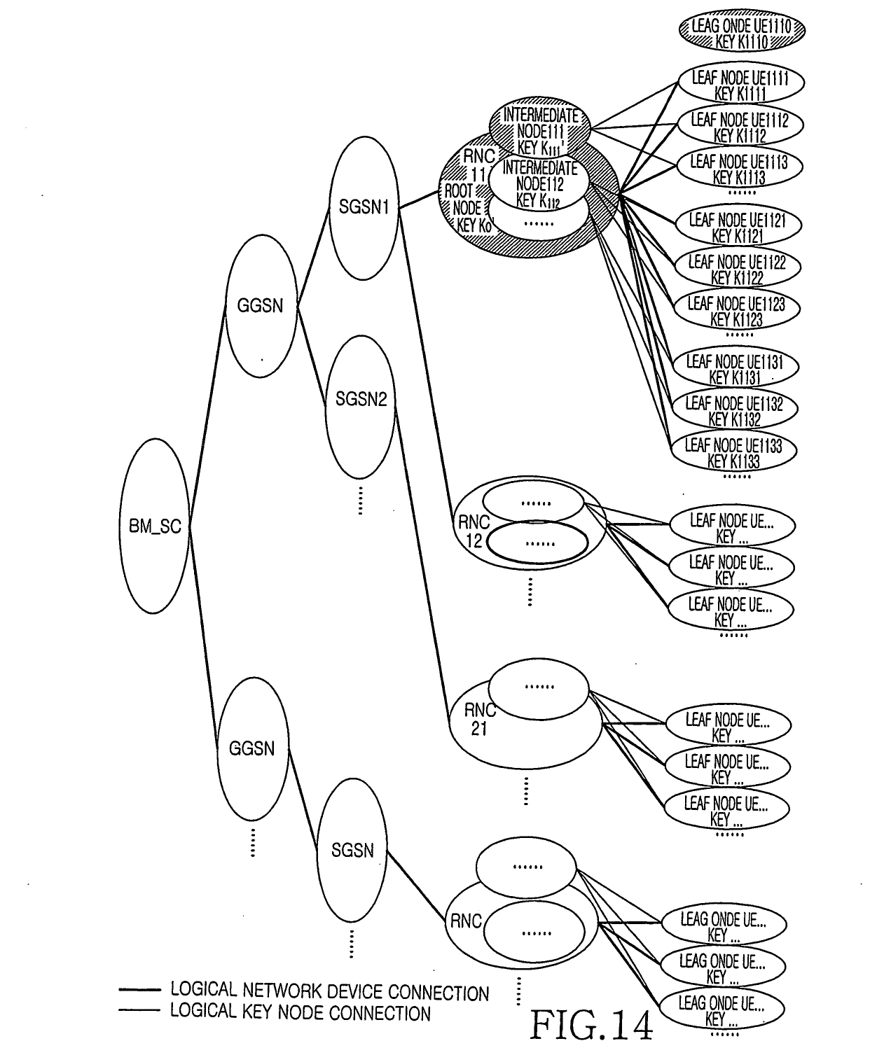

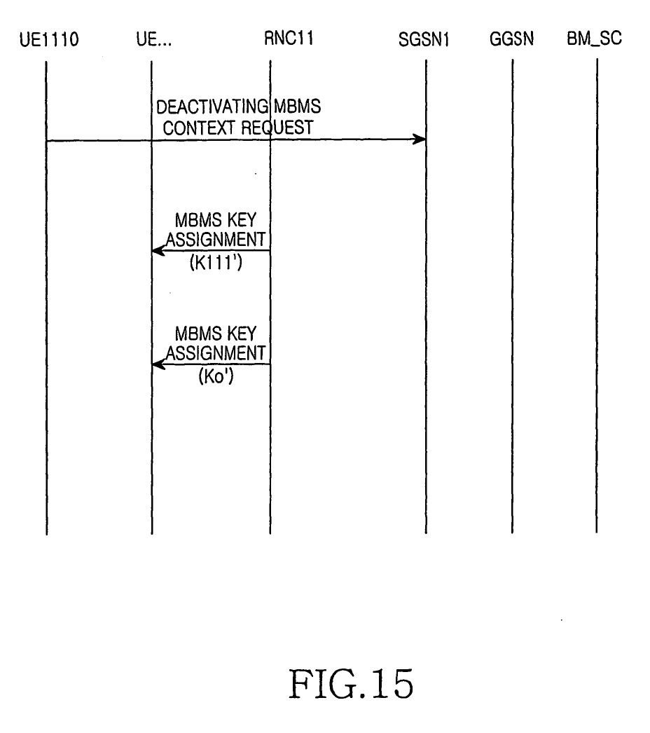

FIG. 9 is the figure illustrating key assignment management and logical network device of the second embodiment of the invention. In this embodiment, the management of each node key is accomplished by the same logical network device and the information encryption process is accomplished by RNC. FIG. 10 is the schematic figure of the corresponding key update assignment when a new user joins MBMS service without causing key updates of other nodes. FIG. 11 is the flowchart corresponding to FIG. 10. FIG. 12 is the schematic figure corresponding key update assignment when a new user joins MBMS service, which causes key updates of other nodes. FIG. 13 is the flowchart corresponding to FIG. 12. FIG. 14 is the schematic view of the corresponding key update assignment when a user leaves MBMS service. FIG. 15 is the flowchart corresponding to FIG. 14.

Please refer to FIG. 9. A BM_SC is connected to several GGSNs at downstream side and provides services for these GGSNs. Each GGSN is connected respectively to several SGSNs at downstream side and provides services for these SGSNs. Each SGSN is connected respectively to several RNCs at downstream side and provides services for these RNCs. Each RNC can also provide services for several user equipments (UEs) at the same time. The solid lines in the figure indicate the conmections between these logical network device entities.

All users within the service range of a RNC are regarded as one MBMS service group, and keys assignment within the group is divided into three layers. RNC acts as the root node, whose key is exactly the group key. All users under a RNC are divided into several sub-groups, and each sub-group corresponds to one intermediate node. For example, the root node key of RNC11 is Ko and RNC11 manages several intermediate nodes, e.g. 111, 112, etc. and assigns nodes keys K₁₁₁, K₁₁₂, etc. for them respectively. Each UE acts as a leaf node, whose key is exactly the private key of the user. For example, the leaf node key of UE 1111 is K₁₁₁₁ and that of UE 1121 is K₁₁₂₁. The dotted lines in the figure indicate the connections between these logic key nodes. Each user keeps node key information on all nodes that the node chain passes by from the leaf node where he/she locates to the root node of the tree, including leaf node, intermediate nodes of respective layers and the root node. For example, UE 1111 keeps the keys K₁₁₁₁, K₁₁₁ and Ko; UE 1112 keeps the keys K₁₁₁₂, K₁₁₁ and Ko; UE 1121 keeps the keys K₁₁₂₁, K₁₁₂ and Ko; and UE 1211 keeps the keys K₁₂₁₁, K₁₂₁ and Ko. MBMS service data are encrypted and transmitted by the root node key Ko.

Please refer to FIG. 10 and FIG. 11. The private key assigned by the wireless communication network system to UE 1110 is K₁₁₁₀. This UE desires to receive MBMS service of current BM_SC and it sends a request to SGSN1 via “Activating MBMS context request” message. After the wireless communication network system finishes a series of operations, it accepts this request. The UE is connected to the tree via its access parent node 111 as a new leaf node 1110. This user needs to obtain the node key K₁₁₁ of its access parent node 111 and the key Ko of the root node. The keys K₁₁₁ and Ko won't be updated due to the joining of the user. The keys K₁₁₁ and Ko are sent to the user by RNC11 via the dedicated channel only used by the user as parameters of the “MBMS key assignment” message in point-to-point mode. The information transferred on the dedicated channel only used by the user includes “MBMS key assignment” message and is encrypted by the leaf node key K₁₁₁₀ of the user (i.e. the private key of the user).

Please refer to FIG. 12 and FIG. 13. The private key assigned by the wireless communication network system to UE 1110 is K₁₁₁₀. This UE desires to receive MBMS service of current BM_SC and it sends a request to SGSN1 by “Activating MBMS context request” message. After the wireless communication network system finishes a series of operations, it accepts this request. The UE is connected to the tree via its access parent node 111 as a new leaf node 1110. This user needs to obtain the node key K₁₁₁ of its access parent node 111 and the key Ko of the root node. The keys K₁₁₁ and Ko will be updated to K₁₁₁′ and Ko′ respectively due to the joining of the user. The keys K₁₁₁′ and Ko′ are sent to the user by RNC11 via the dedicated channel only used by the user as parameters of the “MBMS key assignment” message in point-to-point mode. The information transferred on the dedicated channel only used by the user includes “MBMS key assignment” message and is encrypted by the leaf node key K₁₁₁₀ of the user (i.e. the private key of the user).

In addition, the new key K₁₁₁′ is notified in point-to-multipoint mode to all other leaf node s users 1111, 1112, 1113, etc. that locate under the same parent node 111 as the UE 1110 does. The new key K₁₁₁′ is sent to the final leaf node user by RNC11 via the common channel as a parameter of the “MBMS key assignment” message in point-to-multipoint mode. The contents of “MBMS key assignment” message are encrypted by RNC11 via old key K₁₁₁.

In addition, the new root node key Ko′ is notified to all other leaf node's users that locate under the same root node RNC11 as the UE 1110 does in point-to-multipoint mode. Then, the new key Ko′ is delivered to the final leaf node's users by RNC11 as a parameter of “MBMS key assignment” message via the common channel in point-to-multipoint mode. The contents of “MBMS key assignment” message are encrypted with old key K₁₁₁ by RNC11.

Please refer to FIG. 14 and FIG. 15. The private key assigned by the wireless communication network system for some UE 1110 is K₁₁₁₀. This UE chooses to leave MBMS service of current BM_SC and it sends a message of “Deactivating MBMS contet request” to SGSN11 via RNC11. After the wireless communication network system finishes a series of operations, it accepts this request. The leaf node 1110 is disconnected from its parent node 111. The node keys K₁₁₁ and Ko of the disconnected node 111 and the root node RNC11 are updated to be the new keys K₁₁₁′ and Ko′ respectively and the update of Ko is performed after K₁₁₁ update finishes. The new key K₁₁₁′ is sent to all other leaf node's users 1111, 1112, 1113, etc. that locate under the same parent node 111 as UE 1110 does sequentially by RNC11 via the dedicated channel used by each user as a parameter of the “MBMS key assignment” message in point-to-point mode. Information transferred on the dedicated channel of each user is encrypted with the leaf node key of the user (i.e. the private key of the user). The new key Ko′ is sent to each intermediate node respectively as a parameter of the “MBMS key assignment” message and then is sent by each intermediate node via RNC11 to corresponding final leaf node's user on common channel in point-to-multipoint mode. The contents of “MBMS key assignment” message are encrypted with intermediate node key K₁₁₁′, K₁₁₂ . . . etc. respectively.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claims:

1. A method for key management and assignment for information encryption in a radio network system which include a root node, plurality of intermediate nodes in the root node and plurality of leaf nodes in each intermediate nodes of the radio network system providing Multimedia Broadcast or Multicast service, comprising the steps of:
generating a group key for the root node which has plurality of intermediate nodes as child nodes;
generating intermediate key using the group key for each of the intermediate nodes that owns both one parent node and one or more child nodes having its own intermediate key;
requesting a leaf node key in a user equipment (UE) for the service; and
delivering a private key as a leaf node key to the UE on a dedicate channel.

2. The method as defined in claim 1, wherein each user keeps node key information on all nodes that the node chain where he/she locates to the root node of the tree, including leaf node, intermediate nodes of respective layers and the root node.

3. The method as defined in claim 1, wherein when a new user joins in the service, this user is connected to a node via its access parent node as a new leaf node and this user needs to obtain keys of all nodes including intermediate nodes and root nodes that are passed by the node chain from the access parent node to the root node; these node keys won't be updated due to the joining of the user; the transmissions of these node key are sent to the user sequentially in point-to-point mode and are encrypted by using the key of the new leaf node.

4. The method as defined in claim 1, wherein when a new user joins in the service, this user is connected to a node as a new leaf node via its access parent node and this user needs to obtain keys of all nodes including intermediate nodes and root nodes that are passed by the node chain from the access parent node to the root node; these node keys will be updated due to the joining of the user; for the newly-joined user, the transmissions of these new nodes keys are sent to the user sequentially in point-to-point mode and are encrypted by using the key of the new leaf node.

5. The method as defined in claim 4, wherein for each node that needs key update, new keys will be encrypted with old keys and will be delivered to the final leaf node's users that they belong to in point-to-multipoint broadcast mode.

6. The method as defined in claim 1, wherein when a user leaves the service, a leaf node is disconnected from its parent node and the keys of all nodes that the node chain passes by from the disconnected node to the root node of the tree are sequentially updated.

7. The method as defined in claim 6, wherein for each node that needs key update, the key update of node is performed only after key updates of all its child nodes finish.

8. The method as defined in claim 6, wherein for each node that needs key update, the new node keys are delivered to all child nodes of it one by one in point-to-point mode and are encrypted with key of each child node.

9. The method as defined in claim 8, wherein each child node still uses the corresponding node key to encrypt the new node key, and delivers the new node key to the final leaf node's users that they belong to in point-to-multipoint mode.

10. The method as defined in claim 1, wherein the information encryption process is accomplished by RNC.

11. The method as defined in claim 1, wherein the root node locates in the same logical network device as that intermediate node does.

12. The method as defined in claim 1, wherein said root node locates in the different logical network device from that intermediate node does.
